(19) United States
(12) Patent Application Publication
(10) Pub. No.: US 2026/0338618 A1
(43) Pub. Date: Oct. 29, 2026

(54) TEMPERATURE MEASUREMENT USING MULTIPLE OPTICAL SIGNALS

(71) Applicant: LumaSense Technologies, Inc., Denver, CO (US)

(72) Inventors: Amandeep Singh, San Jose, CA (US); Terry M. Stapleton, San Jose, CA (US); Pierre-Alexandre Gross, Redwood City, CA (US)

(73) Assignee: LumaSense Technologies, Inc., Denver, CO (US)

(21) Appl. No.: 19/192,660

(22) Filed: Apr. 29, 2025

(51) Int. Cl. G01K 11/32

(52) U.S. Cl. CPC G01K 11/32

(57) ABSTRACT

This disclosure describes systems, devices, and methods for determining temperature from a temperature-sensitive material using one or more optical signals. The temperature-sensitive material provides a first optical signal based on photoluminescence in a first temperature range and a second optical signal based on Planck emissions in a second temperature range. The second temperature range can overlap the first temperature range and can extend to higher temperatures than the first temperature range. Temperature information provided by the first optical signal can be used as a reference for determining temperature based on the second optical signal. One or more sensors can be used to sense the optical signal(s). The temperature-sensitive material can include different types of materials that provide the first and second optical signals. The temperature-sensitive material is enclosed in an enclosure designed to reduce or eliminate adhesives and binders. In one embodiment, the enclosure is assembled using a mechanical technique.

### TECHNICAL FIELD

The described embodiments relate generally to thermometry and, more particularly, to systems, devices, and methods for performing temperature measurements using more than one type of optical sensing technology.

### BACKGROUND

Fiber optic thermometry systems perform temperature measurement based on an optical output signal (e.g., light) provided by a temperature-sensitive material. The material may be positioned on the interior of an enclosure, such as a temperature probe, for example. The optical output signal provided by the temperature-sensitive material may be coupled to an optical device via a fiber optic cable, which provides for the bi-directional transmission of light between the optical device and temperature-sensitive material. The optical device may include one or more optical sensors that receive the optical output signal and convert the optical output signal to electrical signals. The optical device may process the electrical signals to determine the temperature of the temperature-sensitive material. In some examples, the fiber optic cable that couples the temperature-sensitive material to the optical device may enable the optical device to be located remotely from the enclosure. Accordingly, a fiber optic thermometry system may enable remote temperature monitoring of harsh or extreme environments (e.g., high-temperature surfaces, environments that may not be human-accessible, and/or other types of extreme environments or conditions). Because temperature measurements are based on optical signals, such a system may provide remote temperature monitoring that is insensitive to a variety of noise sources, such as radio frequency (RF) interference.

Fiber optic thermometry systems may provide temperature measurement capability over a specified range of temperatures, which may be dependent on the type of temperature-sensitive material. For example, a fiber optic thermometry system may be based on a photoluminescence effect of the temperature-sensitive material. In these types of thermometry systems, an optical emitter housed in the optical device may illuminate the temperature-sensitive material during an illumination phase. The temperature-sensitive material may absorb the emitted light during the illumination phase and re-emit light as an optical output signal immediately following the illumination phase. The decay time of intensity of the re-emitted light may be temperature sensitive. The decay time may be measurable over a limited temperature range. For instance, in embodiments that include a phosphor-based temperature-sensitive material, the decay time may be reliably measured over a range of −200° C. to 450° C.

However, it may be desirable for a fiber optic thermometry system to provide temperature measurement capability up to, and beyond, 600° C., for example. The technology described herein includes systems, devices, and methods that enable temperature measurements over a wider temperature range, in a single fiber optic thermometry system. Generally, the fiber optic thermometry systems described herein provide for a wide temperature measurement range by measuring additional optical emissions (e.g., a second optical output signal) from the temperature-sensitive material when measuring temperatures above the typical temperature range of photoluminescence-based systems.

### SUMMARY

Embodiments described herein are directed to systems, devices, and methods for measuring temperature using hybrid thermometry. Some aspects of this disclosure are directed to a system comprising an enclosure, a temperature-sensitive material positioned within the enclosure, and an interconnect to couple optical signals between the temperature-sensitive material and an optical device. The optical device receives a first optical signal from the interconnect and provides a first temperature measurement in a first temperature range, based on the first optical signal. The optical device receives a second optical signal from the interconnect and provides a second temperature measurement in a second temperature range, based on the second optical signal. In various embodiments, the interconnect is coupled to the enclosure using a crimp connection.

In a further aspect, the first optical signal is based on photoluminescence of the temperature-sensitive material and the second optical signal is based on Planck emissions of the temperature-sensitive material. In a further aspect, the optical device comprises a sensor that provides first temperature data based on the first optical signal and second temperature data based on the second optical signal, and wherein the first temperature measurement in the first temperature range is based on the first temperature data and the second temperature measurement in the second temperature range is based on the second temperature data.

In other aspects, the optical device comprises a first sensor to provide first temperature data based on the first optical signal and a second sensor to provide second temperature data based on the second optical signal, and wherein the first temperature measurement in the first temperature range is based on the first temperature data and the second temperature measurement in the second temperature range is based on the second temperature data. In a further aspect, the first sensor and second sensor are positioned in a common sensor package. In another aspect, first sensor comprises a photodiode and the second sensor comprises gallium arsenide.

In other aspects, wherein the first temperature range comprises a first temperature and the second temperature range comprises a second temperature, and the first temperature is less than the second temperature. Further, the first temperature measurement is used as a reference for the second temperature measurement.

In other aspects, the temperature-sensitive material is a first temperature-sensitive material, and the system further comprises a second temperature-sensitive material positioned within the enclosure. The first optical signal is based on photoluminescence of the first temperature-sensitive material and the second optical signal is based on Planck emissions of the second temperature-sensitive material.

Embodiments are also directed to a method comprising receiving a first optical signal from an interconnect, receiving a second optical signal from the interconnect, determining a first temperature of a first temperature-sensitive material in a first temperature range based on the first optical signal, and determining a second temperature of the first temperature-sensitive material in a second temperature range based on the second optical signal. In some aspects, the first output optical signal is based on photoluminescence of at least the first temperature-sensitive material, and the second optical signal is based on Planck emission of at least the first temperature-sensitive material.

In other aspects, the first optical signal is based on photoluminescence of at least the first temperature-sensitive material, and a portion of the second optical signal is further based on Planck emission of at least a second temperature-sensitive material.

Further aspects of the method include receiving the first optical signal at a first sensor, receiving the second optical signal at a second sensor, determining the first temperature in the first temperature range based on temperature data provided by the first sensor, determining the second temperature in the second temperature range based on temperature data provided by the second sensor. In some aspects, the determined first temperature in the first temperature range is used as a reference for the determined second temperature in the second temperature range. In other aspects, the first sensor comprises a photodiode, and the second sensor comprises gallium arsenide.

Embodiments are also directed to a temperature measurement system comprising an enclosure, a first temperature-sensitive material housed within the enclosure and a second temperature-sensitive material housed within the enclosure, and an optical fiber to couple light between the first temperature-sensitive material and a device, and between the second temperature-sensitive material and the device. The device comprises a first sensor responsive to a first wavelength of light generated by the first temperature-sensitive material, a second sensor responsive to a second wavelength of light generated by the second temperature-sensitive material, and a processor to receive first temperature data provided by the first sensor and second temperature data provided by the second sensor. The processor uses the first temperature data to determine a first temperature measurement in a first temperature range and uses the second temperature data to determine a second temperature measurement in a second temperature range.

In some aspects, the first temperature measurement is determined based on photoluminescence of the first temperature-sensitive material and the second temperature measurement is determined based on Planck emission of the second-temperature sensitive material. In further aspects, the first temperature measurement is used as a reference for determining the second temperature measurement. In other aspects, the first temperature measurement is further based on intensity decay of intensity of the first wavelength of light, and the second temperature measurement is further based on an intensity of the second wavelength of light.

In addition to the exemplary aspects and embodiments described above, further aspects and embodiments will become apparent by reference to the drawings and by study of the following description.

### BRIEF DESCRIPTION OF THE DRAWINGS

To easily identify the discussion of any particular element or act, the most significant digit or digits in a reference number refer to the figure number in which that element is first introduced.

FIG. 1 depicts a block diagram of an example fiber optic thermometry system, according to certain aspects of the present disclosure.

FIG. 2 depicts a side cross-sectional view of an example enclosure.

FIG. 3A depicts an example waveform representative of transmitted light provided by an optical emitter.

FIG. 3B depicts example plots of received light that includes a first and second optical output signal.

FIG. 4 depicts a graph of example temperature measurements based on the first and second optical output signals of FIG. 3B.

FIGS. 5A-5B depict aspects of an example assembly technique of some portions of the enclosure depicted in FIG. 2.

FIG. 6 depicts a side cross-sectional view of another example enclosure.

FIGS. 7A-7D depict block diagrams of example optical component arrangements within a set of example optical temperature measurement systems.

FIG. 8 illustrates an example method for providing a temperature measurement.

FIG. 9 depicts a block diagram of an example optical device.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

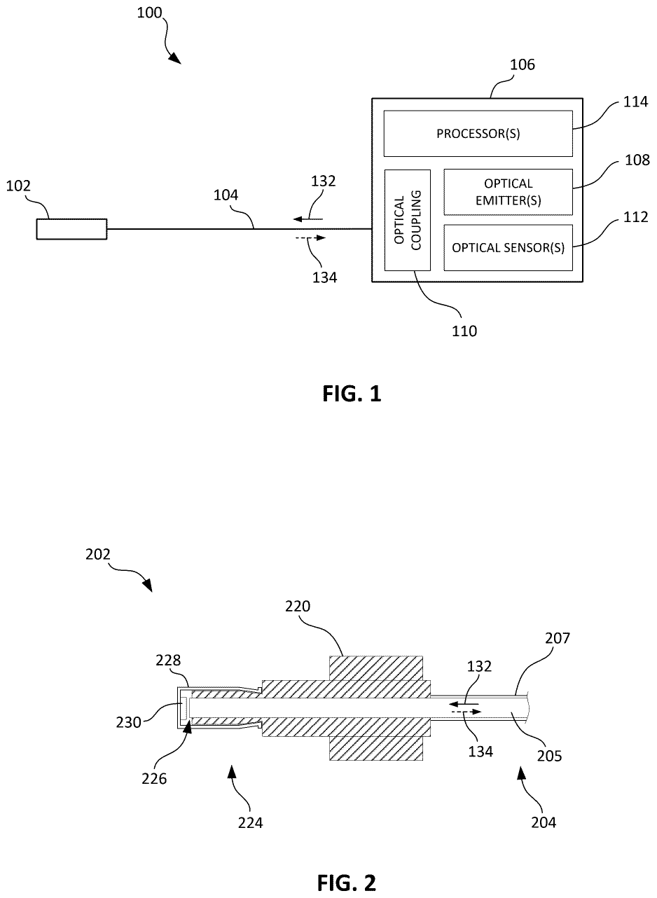

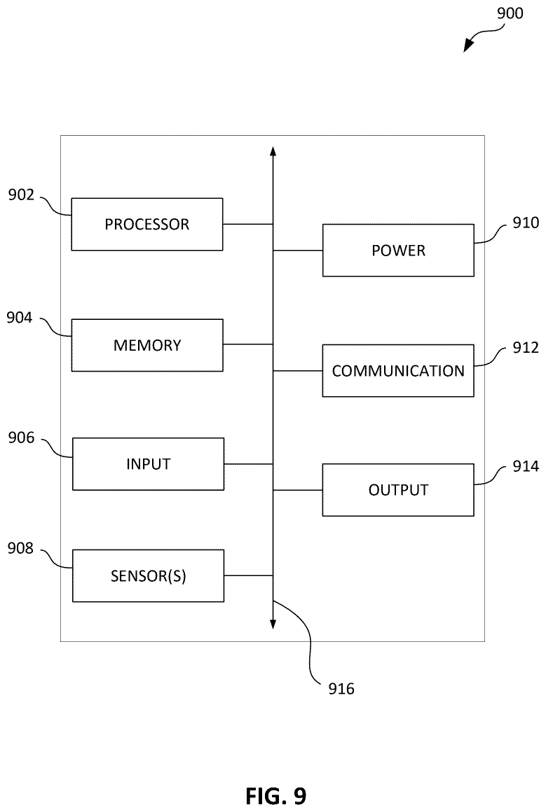

FIG. 1 depicts a block diagram of an example fiber optic thermometry system 100, according to certain aspects of the present disclosure. The system 100 includes an enclosure 102 that includes a temperature-sensitive material. The temperature-sensitive material is optically coupled to an interconnect 104, which is further optically coupled to an optical device 106. The optical device 106 may include one or more optical emitters 108, optical coupling 110, one or more optical sensors 112, and a processor (or processors) 114. In some embodiments, the optical device 106 may include additional components, systems, and/or subsystems, examples of which are described herein with reference to FIG. 9.

To measure temperature, the enclosure 102 may be positioned in contact with, in, or near an object or environment of interest. In some instances, the enclosure 102 may alternatively be referred to as a “temperature probe” or a “probe.” As one or more surfaces of the enclosure changes temperature to that of the object or environment, heat flow causes the temperature-sensitive material to change temperature, accordingly. An example enclosure and temperature-sensitive material is depicted with reference to FIG. 2 and described herein. The temperature-sensitive material emits light based on the temperature of the temperature-sensitive material.

In a first (lower) temperature range, the system 100 may provide temperature measurements based on a first optical output signal that forms part of the emissions from the temperature-sensitive material. For example, in one embodiment, the system 100 may provide temperature measurements in the first range based on photoluminescence of the temperature-sensitive material. For instance, the system 100 may be based on the FluorOptic® thermometry (FOT) system, available from Advanced Energy Industries, Inc. In such a system, optical emitter 108 may emit light that is coupled into the interconnect 104 via optical coupling 110. The transmitted light 132 (solid arrow) may impinge upon, and be absorbed by, the temperature-sensitive material housed within the enclosure 102 during an illumination phase.

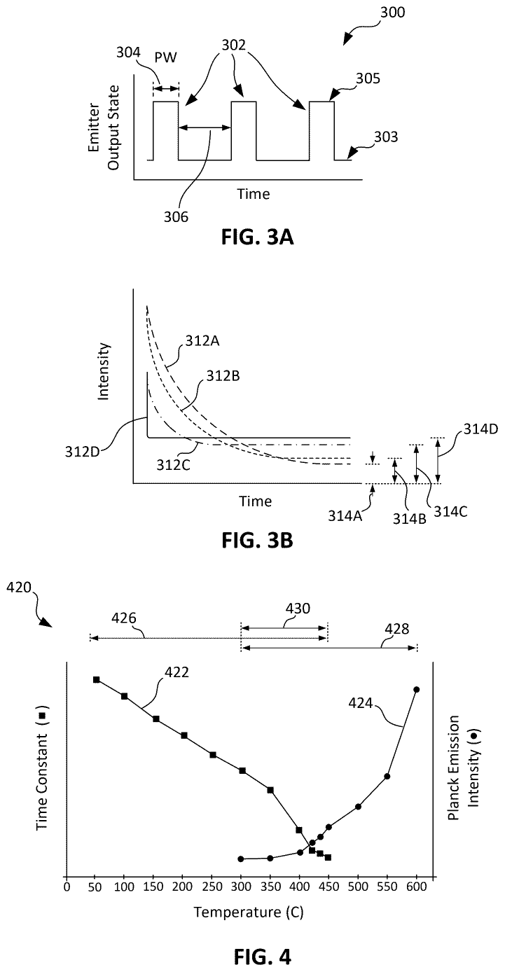

At the end of the illumination phase, the temperature-sensitive material may emit light that is coupled back to the optical device 106 as received light 134 (dashed arrow), via the interconnect 104. The received light 134 is further coupled to the optical sensor 112, through the optical coupling 110. The optical sensor 112 converts the received light 134 to electrical signals that may be processed by processing circuitry (or processor) 114. The processor 114 uses the electrical signals to determine the temperature of the temperature-sensitive material. In one example, the temperature may be determined by analyzing a decay time of the intensity of received light 134. Additional details regarding how temperature may be derived from the first output optical signal are described with reference to FIGS. 3A-3B.

In some variations, the temperature-sensitive material may reflect portions of the transmitted light 132, such that at least a portion of the received light 134 provided to the optical device 106 includes the reflected light. The reflected light may provide information about the temperature of the temperature-sensitive material. For example, the reflected light may provide information about changes in the bandgap of the temperature-sensitive material, which may be used to determine the temperatures. In other variations, the temperature-sensitive material may provide received light 134 based on other aspects of the temperature-sensitive material.

The transmitted light 132 may be provided by the optical emitter 108 at a first wavelength. In one embodiment, the wavelength of the transmitted light 132 may be in the range of 400-650 nm. In other embodiments, the transmitted light 132 may be provided at another wavelength.

The optical emitter 108 may be any of a variety of possible light sources. In one embodiment, the optical emitter 108 may be a type of light emitting diode (LED). In other embodiments, the optical emitter 108 may be another light source, such as a bulb, lamp, laser, or other type of light source. In still other embodiments, the optical emitter 108 may be a combination of two or more light sources. For example, the optical emitter 108 may be a combination of two or more LEDs or may be some other combination of two or more light sources.

The transmitted light 132 is provided to the enclosure 102 through the interconnect 104, which in some cases may be a type of fiber optic cable. For example, the interconnect 104 may include a type of optically transmissive material such as glass, plastic, composite, or other type of material, which allows for the bi-directional transmission of light. As may be understood, the interconnect 104 may be of any of a wide variety of lengths and thicknesses, and may be flexible. The interconnect 104 may allow the enclosure 102 (and temperature-sensitive material) to be positioned remotely from the optical device 106, such as in contact with high-temperature surfaces, or within extreme or hazardous environments.

In some embodiments, the interconnect 104 may include one or more connectors that allow the interconnect 104 to be disconnected from the optical device 106 and/or from the enclosure 102. Accordingly, different enclosures 102 that include different types of temperature-sensitive materials may be interchangeably connected to the optical device 106.

FIG. 2 depicts a side cross-sectional view of an example enclosure 202, which may be one possible embodiment of enclosure 102. The enclosure 202 includes an enclosure housing 220 that receives an interconnect 204. The interconnect 204 is one possible embodiment of interconnect 104. In one example, the interconnect 204 may include a fiber 205 that provides for the transmission of light as described herein. The interconnect 204 may include a jacket 207, which may include one or more layers of protective material that may allow the interconnect 204 to flex, while protecting the fiber 205 from the surrounding environment.

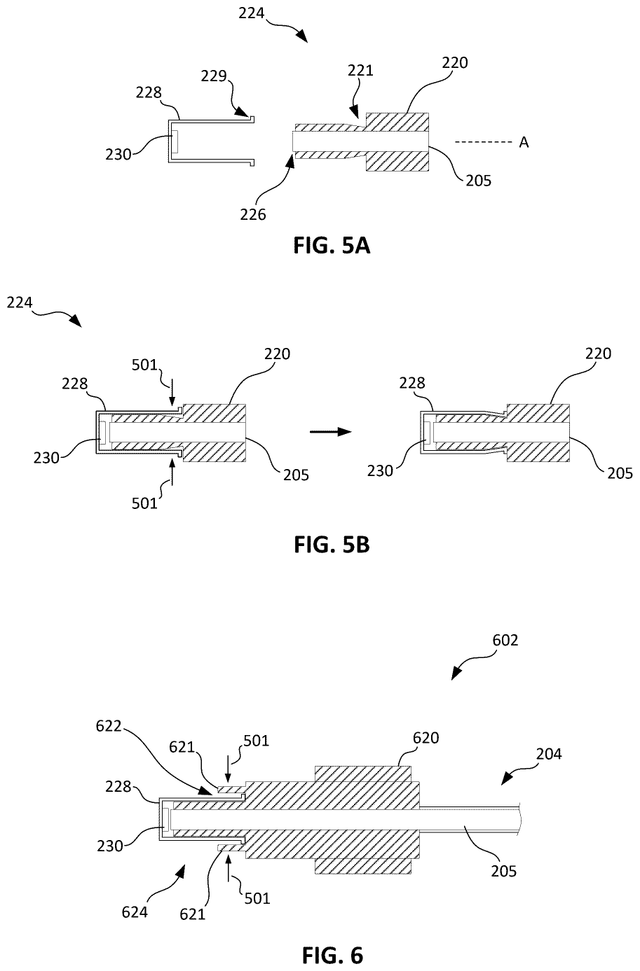

The example enclosure 202 may include a fitting 228 that is attachable to the enclosure housing 220. A method for attaching the fitting 228 to the enclosure housing 220 is provided with reference to FIGS. 5A-5B. The fitting 228 includes temperature-sensitive material 230. In one embodiment, the temperature-sensitive material 230 may include a first temperature-sensitive material capable of absorbing transmitted light 132 during an illumination phase, and re-emitting light following the illumination phase. For example, the first temperature-sensitive material of the temperature-sensitive material 230 may be capable of photoluminescence as described herein (e.g., phosphorescence). The emitted light provided by this photoluminescence is a first optical output signal that forms at least part of the received light 134 provided to the optical device 106.

In further embodiments, the temperature-sensitive material 230 may include a phosphorescent material. In some cases, the temperature-sensitive material 230 may include a single material species capable of phosphorescence (e.g., a single type of phosphor), while in other cases the temperature-sensitive material 230 may include two or more material species capable of phosphorescence (e.g., two or more types of phosphor, a phosphor and another material, or two or more types of non-phosphor material).

As described herein, the first temperature-sensitive material may provide a first optical output signal in a first (lower) temperature range based on photoluminescence. For example, the temperature-sensitive material 230 may include a type of phosphor that re-emits light whose decay time changes with temperature. This change in decay time may be measurable within the first temperature range. As one example, the decay time of re-emitted light may measurably vary over a temperature range that spans from −200° C. to 450° C. In other examples, the first temperature range may span other temperatures (e.g., higher and/or lower temperatures).

The first optical output signal may be provided at one or more wavelengths of light. For example, when the temperature-sensitive material 230 includes a type of phosphor material, the temperature-sensitive material 230 may emit light in the 650-800 nm range. In some instances, the temperature-sensitive material 230 may emit at a single wavelength.

In still other embodiments, in addition to being capable of photoluminescence, the temperature-sensitive material 230 may provide a second optical output signal based on Planck (blackbody) emissions. For example, the temperature-sensitive material 230 may include a type of phosphor that provides a first optical output signal in the first (lower) temperature range based on photoluminescence and provides a second optical output signal in a second (higher) temperature range based on Planck emissions. In some instances, the second temperature range may include temperatures from 300° C. to 600° C., and in other instances may include temperatures up to 800° C. or higher. In still other instances, the second temperature range may span other temperatures (e.g., higher and/or lower temperatures).

In yet other embodiments, the temperature-sensitive material 230 may include additional temperature-sensitive material selected to provide a second optical output signal based on Planck emissions. This second temperature-sensitive material may be incapable of providing an optical output signal based on photoluminescence or may otherwise provide minimal response to the transmitted light 132. In examples, the second temperature-sensitive material may include alumina, silicon (Si), silicon carbide (SiC), or a combination of these and/or other materials capable of providing a second optical output signal in the second temperature range based on Planck emissions.

The second optical output signal may be provided at one or more wavelengths of light. For example, Planck emissions from the temperature-sensitive material 230 may include emitted light in the 600-1000 nm range. In other examples, Planck emissions may include emitted light at other wavelengths. Planck emissions from the temperature-sensitive material 230 may include light emitted at a single wavelength, or light emitted at multiple wavelengths. In some embodiments, the second optical output signal may include wavelengths of light that are within the range of wavelengths of the first optical output signal. For example, emitted light from the temperature-sensitive material 230 may include one or more wavelengths of light that result from Planck emissions, where the one or more wavelengths are a shorter wavelength than that of the light emitted from the temperature-sensitive material 230 as a result of photoluminescence.

Generally, as described herein, the received light 134 provided by the temperature-sensitive material 230 to the optical device 106 may include a first optical output signal based on photoluminescence of a first temperature-sensitive material (e.g., one or more types of phosphor), and may include a second optical output signal based on Planck emissions from the first temperature-sensitive material, a second temperature-sensitive material, or a combination thereof.

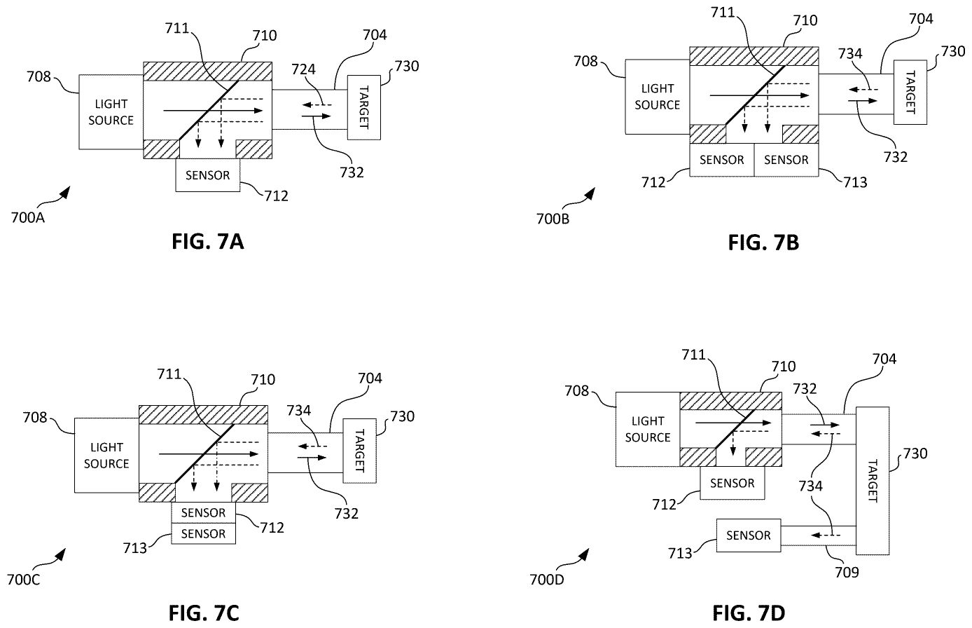

Returning to FIG. 1, the received light 134 is transmitted from the enclosure 102 to the optical device 106, where it is coupled from the interconnect 104 to the optical sensor 112 via the optical coupling 110. In some embodiments, the optical coupling 110 may be a bi-directional optical subassembly (BOSA) that allows transmitted light 132 to be coupled from the optical emitter 114 to the interconnect 104 and allows received light 134 to be coupled from the interconnect 104 to the optical sensor 112. The optical coupling 110 may include any of a variety of optical components, such as one or more filters, beam splitters, lenses, reflective coatings and/or films, and/or other components. Examples of optical coupling 110 are described herein with reference to FIG. 7.

In some embodiments, optical sensor 112 may be a single sensor capable of sensing received light 134 that includes wavelengths associated with the first optical output signal (e.g., photoluminescent emissions in the 650 to 800 nm range) and capable of sensing received light 134 that includes wavelengths associated with the second optical output signal (e.g., Planck emissions in the 600 to 1000 nm range). For example, the optical sensor 112 may be a silicon photodiode, capable of sensing light in the wavelengths described herein. In other examples, the optical sensor 112 may be another type of optical sensor. The optical sensor 112 converts the received light 134 into electrical signals that may be processed to determine the temperature of the temperature-sensitive material.

In another embodiment, the optical sensor 112 may be a combination of two or more sensors. For instance, the optical sensor 112 may include a first sensor capable of sensing light in wavelengths associated with the first output optical signal (e.g., photoluminescent emissions), and a second sensor capable of sensing light in wavelengths associated with the second optical output signal (e.g., Planck emissions). In one example, the first sensor may be a silicon photodiode efficient at sensing light in wavelengths associated with the first optical signal (e.g., 650 to 800 nm). In some cases, the first sensor may be a silicon photodiode that is efficient at sensing light at a single wavelength, while in other cases the first sensor may be a silicon photodiode efficient at sensing light at a range of wavelengths associated with first optical output signal. In other instances, the first optical sensor may be another type of sensor capable of efficiently sensing a single wavelength or multiple wavelengths of the first optical output signal.

The second sensor may be a type of gallium arsenide (GaAs) sensor, such as an indium gallium arsenide (InGaAs) sensor. The second sensor may be efficient at sensing light in wavelengths associated with the second optical output signal (e.g., 600 to 1000 nm). The second sensor may be efficient at sensing a single wavelength of light or multiple wavelengths of light. In other examples, the second sensor may be another type of sensor, which may be efficient at sensing a single wavelength or range of wavelengths of the second optical signal.

As described herein, the first and second optical output signals are converted to respective electrical signals that are analyzed to determine the temperature of the temperature-sensitive material. FIG. 3A depicts an example waveform 300 representative of transmitted light (e.g., transmitted light 132) provided by an optical emitter (e.g., optical emitter 108) and utilized by the temperature-sensitive material to provide the first optical output signal.

The example waveform 300 includes pulses 302 in which the output state of the emitter transitions between a first state 303 and a second state 305. In some embodiments, the first state 303 may represent a state in which the optical emitter is emitting minimal, if any, light (e.g., an “off” state). The second state 305 represents a state in which the optical emitter is emitting light at an intensity suitable to bring about photoluminescence of the temperature-sensitive material (e.g., an “on” state). The second state 305 may represent the illumination phase, as described herein.

When the optical emitter is in the second state 305, the optical emitter may output a single wavelength of light or may output light across a range of wavelengths (e.g., 400 to 650 nm). When the optical emitter emits light at multiple wavelengths, the intensity of light may be constant, or relatively constant, across the emitted wavelengths, or may vary across the emitted wavelengths.

In some embodiments, each of the pulses 302 may have a pulse width (PW) 304. For example, the optical emitter may provide pulses 302 with a PW 304 of 25 ms, within an allowable tolerance (e.g., +/−5%). In other examples, the PW 304 may be smaller or larger than 25 ms, and may have a lower or higher tolerance. In other embodiments, the PW 304 may be varied between pulses 302 and/or groupings or bursts of pulses 302.

In some embodiments, the optical emitter may provide pulses 302 with a fixed and uniform pulse interval 306. For example, the optical emitter may provide pulses 302 with a pulse interval 306 of 25 ms, within an allowable tolerance (e.g., +/−5%). In other examples, the pulse interval 306 may be larger or smaller than 25 ms and may have a lower or higher tolerance. In other embodiments, the pulse interval 306 may be varied between pulses 302 and/or groupings or bursts of pulses 302. In some embodiments, the pulses 302 may be provided with a pulse interval 306 suitable for supporting photoluminescent emissions from the temperature-sensitive material.

In some embodiments, the PW 304 and/or pulse interval 306 may be controlled (such as by a processor or other controller of the optical device) such as to provide pulses 302 at a desired frequency (e.g., 20 Hz) and/or with a desired duty cycle (e.g., 50%). In other embodiments, the example waveform 302 may include more than two output states. For example, the output state of the optical emitter may be varied between three or more states, or may be continually varied.

FIG. 3B depicts example plots 312A-312D of received light that includes a first and second optical output signal. More particularly, the received light may be light received from the temperature-sensitive material (e.g., received light 134) following an illumination phase.

Each of the plots 312A-312D is a plot of the intensity of received light over time for a different temperature of the temperature-sensitive material. For example, plot 312A corresponds to a first (lowest) temperature, plot 312B corresponds to a second temperature higher than the first temperature, plot 312C corresponds to a third temperature higher than the second temperature, and plot 312D corresponds to a fourth temperature higher than the third temperature. Accordingly, a fiber optic thermometry system may determine the temperature of the temperature-sensitive material based on the light intensity decay time, which corresponds to the first optical output signal (e.g., the temperature of the temperature-sensitive material is determined based on photoluminescence). Depending on the measurement capabilities of the fiber optic thermometry system, the decay time may not be measurable at temperatures significantly higher than the fourth temperature, due to the very high rate of decay. Thus, for example, the fourth temperature may represent an upper temperature limit of the first temperature range, in which the first optical output signal may be used to measure temperature. However, temperatures lower than the first temperature (not depicted) may result in measurable decay times, and the optical device may therefore rely on these measurements to determine the temperature.

To determine the temperature of the temperature-sensitive material, the optical device may rely on any of several methods. For example, the optical device may include a look-up table (LUT) that includes data that correlates the decay time to temperature. In some embodiments, the data may be based on material characterization data, calibration or reference data, manufacturing data, and/or other types of data that correlate the decay time to the temperature of the temperature-sensitive material. The LUT may be stored in a memory element of the optical device.

In some embodiments, data provided in the LUT may correspond to the type of temperature-sensitive material connected to the optical device via the interconnect (e.g., interconnect 104, 204). In examples where an optical device may be interchangeably connected to different enclosures that include different types of temperature-sensitive materials, the optical device may be provided with a number of LUTs, each of which corresponds to the type of temperature-sensitive material connected to the optical device. The appropriate LUT may be selected accordingly, such as by a user of the optical device, or automatically using an established method.

In other examples, the optical device may rely on another approach for determining the temperature of the temperature-sensitive material based on the decay time. For instance, the optical device may apply an algorithm (e.g., a mathematical formula or other algorithm) or may use another method to determine the temperature.

The example plots 312A-312D also provide data associated with the second optical output signal. For example, each of the plots 312A-312D includes an offset 314A-314D, respectively, that corresponds to the intensity of Planck emissions. The first offset 314A may correspond to an offset in which no Planck emissions are present. That is, the first temperature may be too low for the temperature-sensitive material to provide a measurable offset (e.g., a measurable Planck emission). The first temperature may therefore represent a lower temperature limit of the second temperature range, in which the second optical output signal may be used to measure temperature. As the temperature of the temperature-sensitive material increases beyond the fourth temperature (not depicted), the optical device may continue to rely on the offset to perform temperature measurements, and may no longer provide temperature measurements based on the decay time.

As the temperature of the temperature-sensitive material increases (e.g., to the second, third, and fourth temperatures) the corresponding offset (e.g., the second offset 314B, third offset 314C, and fourth offset 314D) increases. These offsets may be used to determine the temperature. For example, an optical device may measure the offset and use a second LUT that includes data correlating the offset to the temperature of the temperature-sensitive material. In some embodiments, the data may be based on material characterization data, calibration or reference data, manufacturing data, and/or other types of data that correlate the offset 314A-314D to the temperature of the temperature-sensitive material.

In some embodiments, data provided in the second LUT may correspond to the type of temperature-sensitive material connected to the optical device via the interconnect (e.g., interconnect 104, 204). In examples where an optical device may be interchangeably connected to different enclosures that include different types of temperature-sensitive materials, the optical device may be provided with a number of LUTs, each of which corresponds to the type of temperature-sensitive material connected to the optical device. The appropriate LUT may be selected as the second LUT accordingly, such as by a user of the optical device, or automatically using an established method.

In other examples, the optical device may rely on another approach for determining the temperature of the temperature-sensitive material based on the offset 314A-314D. For instance, the optical device may apply an algorithm (e.g., a mathematical formula or other algorithm) or may use another method to determine the temperature.

FIG. 4 depicts a graph 420 of example temperature measurements based on the first and second optical output signals of FIG. 3B. First data 422 corresponds to temperature measurements based on the first optical output signal (e.g., based on the decay time associated with photoluminescence) and second data 424 corresponds to temperature measurement based on the second optical output signal (e.g., based on offsets associated with Planck emissions). In the example depicted, the first data 422 corresponds to temperatures in a first temperature range 426 that spans from 50° C. to 450° C. In other examples, the first temperature range 426 may include higher and/or lower temperatures, as described herein (e.g., the first temperature range 426 may include 200° C. to 450° C.). Also depicted in FIG. 4, the second data 424 corresponds to temperatures in a second temperature range 428 that spans from 300° C. to 600° C. In other examples, the second temperature range 428 may include higher and/or lower temperatures, as described herein (e.g., the second temperature range may include 300° C. to 800° C.).

As further depicted in FIG. 4, the first and second temperature ranges 426, 428 may overlap, such as in a third temperature range 430 between 300° C. and 450° C. Accordingly, temperature measurements that are based on first data 422 in the third temperature range 430 may be used as a reference for temperature measurements that are based on second data 424 in the third temperature range 430. For example, temperature measurements derived from first data 422 in the third temperature range 430 may be used to provide a form of error correction for temperature measurements derived from second data 424 in the third temperature range 430. In some cases, the error correction may be applied to, or may otherwise affect, temperature measurements that use the second data 424 at temperatures higher than the third temperature range 430 (e.g., for temperature measures using second data 424 in portions of the second temperature range 428 that are higher than the third temperature range 430). In some embodiments, this error correction may include offset correction, drift correction, or a combination of these and/or other types of error correction. The error correction may include correcting or modifying data provided in the second LUT, such as by applying a correction factor to the data from the second LUT, or modifying the second LUT data via an algorithm using first data 422 in the third range.

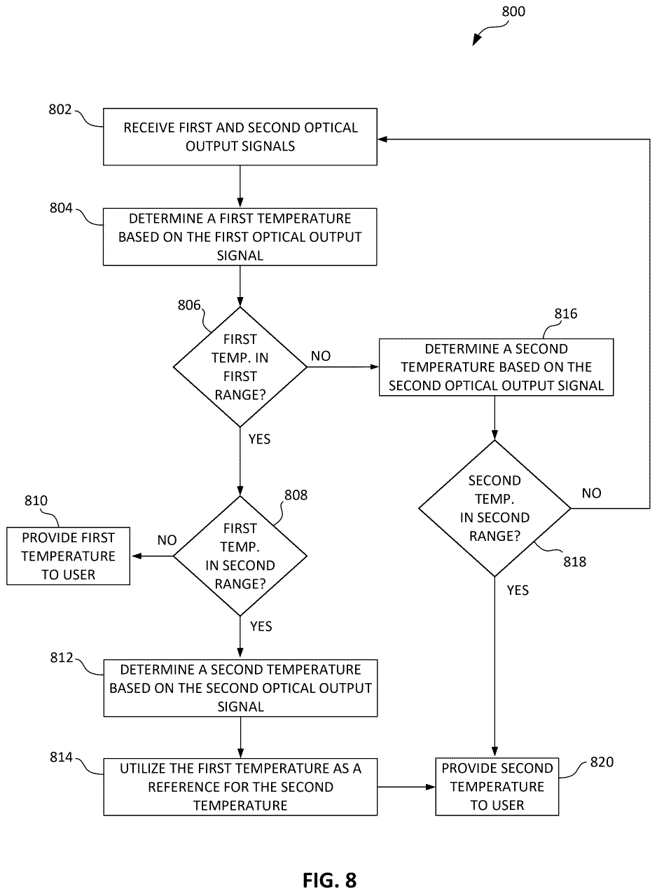

The optical device may provide a temperature measurement to the user, based on a temperature range of the measurement. A method for providing a temperature measurement to the user is described with reference to FIG. 8.

As described herein, at temperatures above 450° C. (e.g., higher than temperatures in the third temperature range 430), the optical system may provide temperature measurements based on the second optical output signal. Accordingly, since the first output optical signal may not be measurable at temperatures above the third temperature range 430, the optical device may disable the output of the optical emitter, such as by powering the optical emitter off or otherwise preventing light emissions from the optical emitter. Similarly, in embodiments where the optical device includes a first sensor for sensing received light associated with the first optical output signal, the optical device may power off the first sensor or may discontinue processing data provided by the first sensor.

At higher temperatures, such as when the temperature of the temperature-sensitive material is within the second temperature range 428, third temperature range 430, and higher portions of the first temperature range 426, aspects of the enclosure (which includes the temperature-sensitive material) may affect the first and/or second optical output signals. For instance, at temperatures near, or higher than, 250° C. to 300° C. materials used to fabricate the enclosure may be affected by the temperature, and may alter or otherwise affect the first and/or second optical output signal. As one example, adhesives and/or other binding agents may be used to connect and secure portions of the enclosure together (e.g., the fitting 228, fiber 205, enclosure housing 220, etc.). At higher temperatures, these adhesives and other binding agents may discolor, melt, or otherwise be physically altered in a way that affects the mechanical reliability of the enclosure. In some cases, higher temperatures may affect light emissions from the temperature-sensitive material, and/or may affect the transmission of light through the temperature-sensitive material and/or interconnect. FIGS. 5A-5B and 6 depict examples of an assembly technique that may reduce or eliminate the need for adhesives and/or other binding agents.

FIGS. 5A-5B depict aspects of an example assembly technique used for some portions of the enclosure 102 depicted in FIG. 2. During assembly, the temperature-sensitive material 230 may be secured within the fitting 228. In some embodiments, the temperature-sensitive material 230 may be secured using one or more adhesives, binders, and/or bonding agents (e.g., a type of epoxy or other adhesive). As described herein, these adhesives and bonding agents may, in some cases, affect emissions from the temperature-sensitive material 230. In other embodiments, the temperature-sensitive material 230 may be secured within the fitting 228 using a mechanical means, such as by pressing the temperature-sensitive material 230 into fitting 228. In some cases, the fitting 228 may include physical features that receive and/or help retain the temperature-sensitive material 230 within the fitting 228.

FIG. 5A depicts a distal end 224 of the enclosure housing 220, prior to positioning the fitting 228 on the enclosure housing 220. As shown, the fiber 205 is positioned in the enclosure housing 220 such that the distal end 226 is positioned to optically couple light to and from the temperature-sensitive material 230 when the fitting 228 is connected. To secure the fitting 228 and fiber 205 to the enclosure housing 220, the fitting 228 is positioned over the distal end 224 of the enclosure housing 220. In some embodiments, the fitting 228 and/or enclosure housing 220 may include physical features that facilitate connection of the fitting 228. For example, the fitting 228 and/or enclosure housing 220 may include one or more mechanical stops, guides, rails, notches, and/or other features that facilitate connection of the fitting 228 to the enclosure housing 220. In some instances, these features may be used to help align the fitting 228 to the enclosure housing 220 and/or fiber 205.

With the fitting 228, fiber 205, and enclosure housing 220 positioned as shown in FIG. 5B, a force 501 is applied to a portion of the fitting 228. The force 501 causes the portion of the fitting 228 to deform and come into contact with portions of the enclosure housing 220. In the example depicted, the distal end 224 of the enclosure housing 220 is shaped to allow portions of the fitting 228 to deform into a recess 221 provided in the enclosure housing 220. This arrangement secures the fitting 228 to the enclosure housing 220, preventing the fitting 228 from detaching. Deformation of the fitting 228 may also cause force to be applied to portions of the enclosure housing 220, which may in turn apply force to portions of the fiber 205. Accordingly, the fiber 205 may also be secured within the enclosure housing 220, whereby the force prevents the fiber 205 (and in general, interconnect 204) from detaching from the enclosure housing 220.

In some embodiments, such as depicted herein, the fitting 228, enclosure housing 220, and fiber 205 are circumferentially symmetric, and the force 501 applied to portions of the fitting 228 may be applied around the entirety of the circumference of the fitting 228. Accordingly, the fitting 228 may deform along the entirety of its circumference, when the force 501 is applied. In other embodiments, the force 501 may be applied at discrete points around the circumference of the fitting 228. For example, the force 501 may be applied at eight points distributed around the circumference of the fitting. In other examples, the force may be applied at greater or fewer discrete points distributed around the circumference of the fitting 228.

In other embodiments, the fitting 228, enclosure housing 220, and/or fiber 205 may not be circumferentially symmetric. In such embodiments, the force 501 may be applied accordingly to portions of the fitting 228 to cause deformation of the fitting 228 along the entirety of the circumference of the fitting 228, or at discrete points around the circumference of the fitting 228, as described herein.

In the example depicted in FIGS. 5A-5B, the fitting 228, enclosure housing 220, and fiber 205 are arranged concentrically with respect to a common axis A. However, this arrangement is not required, and the fitting 228, enclosure housing 220, and/or fiber 205 may, in some embodiments, not be concentrically arranged.

The fitting 228 may be fabricated from any of a variety of malleable materials that permit deformation of the material when force 501 is applied. Further, to support temperature measurement, the material of the fitting 228 may be selected to achieve one or more desired thermal properties, such as thermal conductivity, thermal mass, etc. In some embodiments, the material of the fitting 228 may be a type of metal, such as aluminum, steel, or other type of metal. In other embodiments, the fitting 228 may be formed from an alloy of two or more metals, or may be formed from another type of material, or combination of materials, that is deformable and suitable for temperature measurement. In some variations, the fitting 228 may not be the same material throughout. For instance, a first one or more portions of the fitting 228 may be fabricated from a first type of one or more materials, and a second one or more portions of the fitting 228 may be fabricated from a second type of one or more materials. In other instances, the fitting 228 may be fabricated from a multitude of materials, which may allow the fitting 228 to be deformable over some portions and rigid or relatively rigid (e.g., non-deforming) over other portions.

The enclosure housing 220 may be fabricated from any of a variety of materials. For example, the enclosure housing 220 may be fabricated from one or more types of ceramics, metals, plastics, composite materials, and/or a combination thereof. In some embodiments, the material and design of the enclosure housing 220 are such that portions of the enclosure housing 220 that experience the applied force 501 substantially maintain an original shape or otherwise experience minimal deformation.

The applied force 501 may be generated using any of a variety of methods. For example, force 501 may be applied via a mechanical apparatus that may include a collet, chuck, vice, crimp tool, other apparatus, or a combination thereof. As described herein, the mechanical apparatus may apply force 501 uniformly or non-uniformly around the circumference of the fitting 228. In some examples, a positioning jig may be used to maintain the relative positions of the fitting 228, enclosure housing 220, and fiber 205 during application of the force 501.

In other embodiments, the fitting 228, enclosure housing 220, and/or fiber 205 may be connected by other methods. For example, fasteners such as screws, bolts, rivets, and/or other types of fasteners may be used to connect and secure the fitting 228, enclosure housing 220, and fiber 205 together. Additionally or alternatively, the fitting 228, enclosure housing 220, and/or fiber 205 may be connected by still other methods, such as by a type of welding (e.g., laser welding), fusing, or a combination of these and/or other methods.

FIGS. 5A-5B depict an example in which the fitting 228 is connected to the enclosure housing 220 by positioning the fitting 228 around the exterior of a portion of the enclosure housing 220. FIG. 6 depicts a side cross-sectional view of another example enclosure 602, in which the fitting is received on an interior portion of the enclosure housing 620. In the example shown, the distal end 624 of the enclosure housing 620 includes an outer ring 621 which creates a pocket 622 into which the fitting 228 may be inserted. Force 501 may be applied to portions of the ring 621 to cause deformation of the ring 621 (or portions of the ring 621), which may press against portions of the fitting 228. In this manner, the fitting 228 may be secured to the enclosure housing 620. Further, the ring 621, when deformed and pressed against the fitting 228, may cause force to be transmitted to the fiber 205. The transmitted force may cause the fiber 205 to be retained within the enclosure housing 602.

In some examples, the fitting 228 may include physical features that aid retention of the fitting 228 to the enclosure housing 620. For instance, the fitting 228 may include a tab 229 (FIG. 5A). In this example, the tab 229 is a single continuous tab arranged around the circumference of the fitting 228. In other examples, the fitting 228 may include two or more tabs, or other features, positioned along the outer circumference of the fitting 228. When the ring 621 is deformed, the tab 229 may engage the ring 621 and help retain the fitting 228. In other examples, the ring 621 may also include one or more tabs that engage the tab 229 of the fitting 228, which may further help retain the fitting 228. In still other examples, the fitting 228 may not include a tab 229, and the ring 621 (or other deformable portion of the enclosure housing 620) may or may not include a tab or tabs, or other retention feature.

In some embodiments, the tab 229 may serve (or may also serve) as a physical feature that aids in the application of force 501, such as by a mechanical apparatus as described herein. For instance, the tab 229 may help align the mechanical apparatus to the fitting 228 so that force 501 may be suitably applied.

In further embodiments, following application of the force 501, the tab 229 may be removed from the fitting 228. For example, in some temperature measurement applications, and/or for some enclosure designs (not depicted), the tab 229 may be removed so that the outer surface of the enclosure is smooth, or so that the tab 229 does not otherwise interfere with use of the fiber optic thermometry system. In some instances, the tab 229 may be removed by a machining process (e.g., grinding, sanding, etc.). In other instances, the tab 229 and/or fitting 228 may be designed such that application of force 501 (such as by a mechanical apparatus) causes the tab 229 to detach, without the need for additional processes.

In other embodiments, a sacrificial split-ring (not depicted) may be used to connect portions of the enclosure 602. For example, the split-ring may form a portion of, or may be formed on, the ring 621, other portions of the enclosure housing 620, or other portion of the enclosure 602. The split-ring may be made from a malleable material. Circumferential force may be applied to the split-ring to cause deformation of the underlying material of the enclosure housing 620, which may cause the fitting 228 to be retained to the enclosure housing 620. In some examples, the deformation of the enclosure housing 620 due to the force applied to the split-ring may also cause the fiber 205 to be retained within the enclosure 602. With the fitting 228 and fiber 205 retained to the enclosure housing 620, the split-ring may be removed (e.g., peeled away or otherwise detached) and discarded.

FIGS. 7A-7D depict block diagrams of example optical component arrangements within a set of example optical temperature measurement systems 700A-700D, respectively. FIG. 7A depicts example optical temperature measurement system 700A, which includes a light source 708, sensor 712, optical coupling 710, interconnect 704, and target material 730. It should be understood that the light source 708, optical coupling 710, and sensor 712 may be part of an optical device, such as optical device 106. To aid visualization, other components of the optical device (e.g., a housing, processor, etc.) are not depicted in FIGS. 7A-7D. A block diagram of an example optical device is presented herein and described with reference to FIG. 9.

The light source 708 may be similar to, or substantially the same as, optical emitter 108 described herein with reference to FIG. 1, and may perform the same or similar function. For example, the light source 708 may be a type of LED (or other type of light source) capable of providing transmitted light 732 at a wavelength suitable for causing photoluminescence of the target material 730. The light source 708 may, in some variations, include multiple LEDs or other light sources.

The target material 730 represents a temperature-sensitive material, which may be similar to, or substantially the same as, temperature-sensitive material 230, described herein with reference to FIGS. 2, 5A-5B, and 6. The target material 730 may provide photoluminescent emissions and Planck emissions, which contribute to received light 724 transmitted toward the optical coupling 710. The interconnect 704 may be similar to, or substantially the same as, interconnects 104, 204, and may perform the same function as described herein. The interconnect 704 couples the received light 724 to the optical coupling 710.

The optical coupling 710, may be similar to, or substantially the same as, optical coupling 110. For instance, the optical coupling 710 may be a BOSA. In the example depicted, the optical coupling 710 includes a beam splitter 711, which may allow the transmitted light 732 to be transmitted from the light source 708 toward the interconnect 704 with minimal, if any, loss of energy. The beam splitter 711 may include a coating or film that reflects the received light 724 toward the sensor 712.

The example depicted in FIG. 7A is an embodiment in which a single sensor (sensor 712) is capable of sensing the first optical output signal (e.g., light wavelengths associated with photoluminescence) and the second optical output signal (e.g., light wavelengths associated with Planck emissions). For example, sensor 712 may be a photodiode capable of sensing 600 to 1000 nm wavelengths.

In some embodiments, the optical coupling 710 may include additional optical components, such as one or more lenses, filters, beam splitters, combiners, reflective components, coupling components, and/or other optical components. As an example, the optical coupling 710 may include one or more filters that block wavelengths of light that are smaller and/or larger than wavelengths associated with the first and/or second optical output signals.

Additionally or alternatively, the example system 700A may include optical components not depicted in FIG. 7A. For instance, example system 7A may include optical components positioned between the interconnect 704 and optical coupling 710, between the optical coupling 710 and sensor 712, and/or between the light source 708 and optical coupling 710. The system 700A may include optical components positioned between the target material 730 and interconnect 704 (such as may be part of enclosure 102, 202), and/or may include optical components as part of the interconnect 704. The optical components may include one or more lenses, filters, beam splitters, combiners, reflective components, coupling components, and/or other optical components.

FIG. 7B depicts an example system 700B that includes a first sensor 712 and a second sensor 713. The sensors 712, 713 may be positioned such that received light 734 is coupled to both sensors 712, 713 via optical coupling 710. In one example, the sensors 712, 713 may be separate sensor components, positioned to receive the received light 734. In other examples, sensors 712, 713 may be positioned in a common sensor package. For instance, the first sensor 712 may be positioned adjacent to the second sensor 713 in a single sensor housing or sensor package, or as a sensor subassembly. In another instance, the first sensor 712 and second sensor 713 may be included on a common substrate, such as (for example) the substrate of a single integrated circuit (IC), and positioned to receive the received light 734.

In some embodiments, the first sensor 712 may be a silicon photodiode, capable of sensing wavelengths associated with the first optical output signal (e.g., to sense photoluminescent emissions). The second sensor 713 may be a type of GaAs sensor (e.g., an InGaAs sensor), capable of sensing wavelengths associated with the second optical output signal (e.g., to sense Planck emissions). In other embodiments, the sensors 712, 713 may be other types of sensors, suitable for sensing wavelengths associated with the first and second optical output signals, respectively.

In variations where the sensors 712, 713 are included on a common substrate (e.g. an IC), in some embodiments, each of the sensors 712, 713 may include a plurality of sensing regions for sensing wavelengths associated with the first optical output signal and second optical output signal, respectively. For instance, the sensors 712, 713 may each include a plurality of sensing regions that are distributed across the common IC, such as in a checkerboard pattern or other arrangement. In some embodiments, the common IC may be a type of complementary metal-oxide-semiconductor (CMOS) sensor, that includes one or more sensing regions that correspond to the first sensor 712 and second sensor 713. In some variations, the common IC may include analog and/or digital circuitry (not depicted), such as on one or more layers of the common substrate or IC, or as a second substrate or second IC associated with the common IC. The circuitry may be used to provide electrical signals based on the first and second optical output signals. The circuitry may be connected to one or both of the sensors 712, 713. In some variations, the second IC and common IC may be arranged as a type of front-side illuminated (FSI) sensor or a type of back-side illuminated (BSI) sensor.

As described herein, in some embodiments, the first sensor 712 may be incapable of sensing, or inefficient at sensing, wavelengths of received light 734 associated with the second optical output signal. Similarly, the second sensor 713 may be incapable of sensing, or inefficient at sensing, wavelengths of received light 734 associated with the first optical output signal.

The remaining components of example system 700B (e.g., light source 708, optical coupling 730, interconnect 704, and/or target material 730) may substantially the same as, or similar to, corresponding components described with reference to FIG. 7A.

FIG. 7C depicts an example system 700C that includes a first sensor 712 and a second sensor 713. In the embodiment depicted, the sensors 712, 713 are positioned in a stacked arrangement, with the first sensor 712 positioned between the second sensor 713 and the optical coupling 710. The first sensor 712 may be designed to permit passage of the received light 734 (or portions thereof) through the first sensor 712, so that at least portions of the received light 734 may be received by the second sensor 713.

In one embodiment, the sensors 712, 713 may be part of a stacked sensor or stacked sensor array, in which each of the sensors 712, 713 is a layer in the stack. In one example, the first sensor 712 may be implemented as a first IC and the second sensor 713 may be implemented as a second IC. The first IC may be stacked above the second IC, such that the received light 734 is first received by the first IC, then by the second IC. In another embodiment, the first sensor 712 may be a first layer of a common IC in which the second sensor 713 is implemented as a second (lower) layer of the same IC.

In some embodiments, the first sensor 712 may substantially absorb, or otherwise filter, wavelengths of the received light 734 corresponding to the first optical output signal and may provide electrical signals based on the first optical output signal. The first sensor 712 may allow passage of wavelengths of the received light 734 corresponding to the second optical output signal. The second sensor 713 may provide electrical signals based on the second optical output signal. The stacked sensor arrangement may, in same cases, include filtering components and/or other optical components. For example, one or more filter components may be positioned between the first sensor 712 and second sensor 713. Additionally or alternatively, the stacked sensors may include optical components above the first sensor 712 (e.g., closer to the optical coupling 710), such as one or more filters, lenses, and/or other optical components, or in other locations.

In some embodiments, in addition to the sensors 712, 713, the stacked sensor may include analog and/or digital circuitry (not depicted), such as in a third stacked IC, or as one or more layers in a common IC. The circuitry may be used to provide electrical signals based on the first and second optical output signals. The circuitry may be connected to one or both of the sensors 712, 713. In some variations, the stacked sensor may be a type of FSI or BSI sensor.

In the example system 700C, the first sensor 712 is depicted as being positioned between the second sensor 713 and optical coupling 710. However, this arrangement is not required. In other examples, the second sensor 713 may be positioned between the first sensor 712 and the optical coupling 710.

The remaining components of example system 700C (e.g., light source 708, optical coupling 730, interconnect 704, and/or target material 730) may be substantially the same as, or similar to, corresponding components described with reference to FIGS. 7A-7B.

FIG. 7D depicts an example system 700D that includes a first sensor 712 and a second sensor 713. The light source 708, optical coupling 710, and first sensor 710 are positioned as described herein with reference to FIG. 7A. However, in example system 700D, the first sensor 712 may be capable of sensing wavelengths of received light 734 corresponding to the first optical output signal. Further, received light 734 is coupled to the first sensor 712 via a first interconnect 704, which may be similar to, or substantially the same as interconnect 104, 204, and may perform substantially the same function.

The example system 700D also includes a second interconnect 709, which may be similar to, or substantially the same as, interconnect 704. The second interconnect 709 is arranged to transmit received light 734 from the target material 730 to the second sensor 713. The second sensor 713 may be capable of sensing wavelengths of received light 734 corresponding to the second optical output signal.

In some embodiments, the first interconnect 704 may be bundled, or otherwise included, together with the second interconnect 709, in a single subassembly. For instance, the interconnects 704, 709 may be distinct fiber optic cables bundled together in a single jacket, forming a larger single cable or other single structure. In other embodiments, the first interconnect 704 and second interconnect 709 may be distinct from one another, forming two physically distinct connections to the target material (e.g., to the enclosure 204). Though connected to the target material 730 via separate interconnects 704, 709, respectively, the sensors 712, 713 may be included in a common housing of an optical device (e.g., optical device 106).

The remaining components of example system 700D (e.g., light source 708, optical coupling 730, and/or target material 730) may be substantially the same as, or similar to, corresponding components described with reference to FIGS. 7A-7C.

While example systems 700A-700D depict sensors 712 and 713 (where applicable) as being oriented 90° angle relative to the light source 708, this orientation is not required. For example, one or both sensors 712, 713 may be oriented at other angles relative to the light source 708, and the optical coupling 710 (and elements thereof) may be designed to direct light accordingly. In other embodiments, one or both sensors 712, 713 may be positioned substantially adjacent to the light source 708, or may be otherwise positioned and/or oriented differently than the depictions of FIGS. 7A-7D. In still other embodiments, the positions of light source 708 and sensors 712, 713 may be opposite of the depictions, such that the light source 708 may be positioned where sensors 712, 713 are currently shown, and sensors 712, 713 may be positioned where light source 708 is currently shown. In yet other examples, the positions of the light source 708, sensors 712, 713, and/or fiber 704 may assume any position relative to the optical coupling 710 such as to suitably perform the temperature measurements described herein.

FIG. 8 illustrates an example method for providing a temperature measurement using the technology described herein. In some cases, one or more aspects of the method 800 may be performed by one or more components of an optical device (e.g., optical device 106). For example, the method 800 may be performed by one or more processors (e.g., processor 114) and/or processing circuitry of the optical device, or other components thereof. In some embodiments, the processor may include or be coupled to memory that may store instructions that, when executed by the processor, cause the processor to perform the operations of the method 800. While performing the steps of the method 800, the processor may also cause the optical device, and/or one or more components thereof, to perform or discontinue various operations. Components of an exemplary optical device are described herein with reference to FIG. 9. In some cases, the method 800 may be performed consistent with one or more of example waveform 300, example plots 312A-312D, or graph 420.

At step 802, the method 800 includes receiving first and second optical output signals from a temperature-sensitive material (e.g., temperature-sensitive material 230, 730). As described herein, the first optical output signal may be associated with wavelengths of light that are emitted from the temperature-sensitive material due to photoluminescence, and received by one or more sensors of the optical device. The second optical signal may be associated with wavelengths of light that are emitted from the temperature-sensitive material due to Planck (e.g., blackbody) emissions, and received by one or more sensors of the optical device

At step 804, the method 800 includes determining a first temperature based on the first optical output signal. In some embodiments, the first optical output signal may indicate a time rate of decay of the intensity of the received light. Determining the first temperature may include correlating the rate of decay with a temperature, such as by using one or more LUTs stored in a memory structure of the optical device. In other examples, the first temperature may be determined by other methods, and/or by using other aspects of the first optical signal and/or received light.

At step 806, the method 800 includes determining whether the first temperature is within a first temperature range. The first temperature may be within the first temperature range when the first temperature is greater than or equal to a lowest temperature of the first temperature range, or less than or equal to a highest temperature of the first temperature range.

In examples where the first temperature is determined to be within the first temperature range, at step 808, the method 800 includes determining if the first temperature is in a second temperature range, wherein a highest temperature of the second temperature range is higher than the highest temperature of the first temperature range. The first temperature may be within the second temperature range when the first temperature is greater than or equal to a lowest temperature of the second temperature range and less than or equal to the highest temperature in the second temperature range.

In examples where the first temperature is determined to not be within the second temperature range, at step 808 the first temperature is provided to a user of the optical device. For example, the temperature may be provided to the user in a visual format, such as on a display associated with the optical device, and/or may be provide to the user in an audio format, such as through a speaker associated with the optical device.

In examples where the first temperature is determined to be within the second temperature range, at step 812, the method 800 includes determining a second temperature based on the second optical output signal. In some embodiments, the second optical output signal may indicate an offset in the intensity of the received light. Determining the second temperature may include correlating the offset with a temperature, such as by using one or more LUTs stored in a memory structure of the optical device. In other examples, the second temperature may be determined by other methods, and/or by using other aspects of the second optical signal and/or received light.

At step 814, the method 800 includes utilizing the first temperature as a reference for the second temperature. In examples, the first temperature may be used to provide a form of error correction, which may include offset correction, drift correction, or a combination of these and/or other types of error correction of the second temperature. In some examples, data associated with the provided error correction may be stored in a memory structure of the optical device and applied to a current and/or future second temperature value. In some cases, data associated with the provided error correction may be used to modify data provided by one or more LUTs, or may be used to modify (e.g., update) one or more of the LUTs themselves.

At step 820, the method includes providing the second temperature to the user, such as by visual and/or audio methods. In some variations, when the first temperature is in both the first and second temperature ranges, the method 800 may include providing the first temperature to the user, rather than the second temperature.

Returning to step 806, in examples where the first temperature is not in the first temperature range, at step 816, the method 800 includes determining the second temperature based on the second optical output signal, such as described herein for step 812. In some embodiments, determining the second temperature may include applying error correction, which may be determined using the first optical output signal, as described for step 814 (e.g., from a previous iteration of the method 800).

In some variations, step 812 may include determining the second temperature based on a combination the second optical output signal and aspects of the first optical output signal. For instance, in embodiments where a first sensor provides the first optical output signal (e.g., sensor 712) and a second sensor provides the second optical output signal (e.g., sensor 713), the first optical output signal may include offset information indicative of Planck emissions. The second temperature may be determined based on a linear or non-linear combination of the second optical output signal and aspects of the first optical output signal that are associated with Planck emissions.

In other variations, determining the second temperature may include determining an intermediate temperature, based on the second optical output signal. The second temperature may then be determined based on a linear or non-linear combination of the first temperature and intermediate temperature. For example, the second temperature may be determined based on a weighted average of the first temperature and the intermediate temperature.

At step 818, the method 800 includes determining whether the second temperature is within the second temperature range. The second temperature may be within the second temperature range when the second temperature is greater than or equal to a lowest temperature of the second temperature range, or less than or equal to a highest temperature of the second temperature range.

In examples where the second temperature is determined to be within the second temperature range, at step 820, the method 800 includes providing the second temperature to the user, as described herein.

In examples where the second temperature is determined not to be within the second temperature range, the method 800 may return to step 802. In this case, the temperature is not within the first or second temperature ranges (e.g., the temperature is out of range), and a temperature measurement may not be possible. Accordingly, the optical device may continue to receive the first and second optical output signals (or may receive subsequent optical output signals from one or more additional illumination phases) and may again perform the steps of the method 800 to determine temperature.

As described herein, the temperature-sensitive material may, in some cases, include a first temperature-sensitive material and a second temperature-sensitive material. Accordingly, the steps described for method 800 may include determining a first temperature using the first optical output signal provided by the first temperature-sensitive material and determining a second temperature using the second optical output signal provided by the second temperature-sensitive material.

It should be understood that, in some implementations, the method 800 may occur out of the order presented. For example, steps shown in succession may, in fact, be executed substantially concurrently, or the steps may sometimes be executed in the reverse order, depending upon the functionality involved. As described herein, steps of the method 800 may be repeated continuously, or in some examples, as needed, such as may be directed by a processor, controller, or by other methods.

FIG. 9 depicts a block diagram of an example optical device 900. The example system 900 may be an embodiment of, or otherwise represent, optical device 106 (or other optical devices described herein). The example device may include a processor 902, memory 904, an input system 906, one or more sensors or a sensor system 908, an electrical power system 910, a communication system 912, and an output system 914, which may communicate over one or more busses, generally presented as bus 916. In some variations, optical device 900 may include fewer or additional components, systems and/or subsystems.

Optical device 900 includes processor 902, which may be implemented as one or more processors, microprocessors, microcontrollers, central processing units (CPUs), graphics processing units (GPUs), programmable logic arrays (PLAs), programmable array logic (PALs), complex programmable logic devices (CPLDs), application-specific integrated circuits (ASICs), field-programmable gate arrays (FPGAs), other programmable logic devices (PLDs), and/or a combination of these and/or other processing components. In some embodiments, the processor 902 may include digital and/or analog circuitry capable of processing signals and implementing the methods described herein. The processor 902 may be in communication with each of the systems of optical device 900 (e.g., input 906, sensor 908, electrical power 910, communication 910, and output 914), and may receive signals from each of these systems, and/or provide control of aspects of each.

Optical device 900 includes memory 904, which may include one or more types of memory storage components. For example, memory 904 may include any suitable type of random-access memory, read-only memory, flash memory, removable memory, or a combination of these and/or other types or forms of memory storage. The memory 904 can store electronic data such as, for example, computer programs, instructions, algorithms, timing and/or control signals or data, data structures, databases, LUTs, sensor data, user settings, numeric values, variables, temperature ranges (e.g., upper and/or lower temperature range limits), and so on. The processor 902 may execute instructions and/or programs stored in memory 904, that when executed allow the processor 902 to perform one or more of the operations, steps, and/or functions with respect to the devices and systems described herein.

The input system 906 may be used to receive input from a user of the optical device 900. For example, the input system 906 may include one or more buttons, switches, knobs, keyboards, mice, and/or other types of inputs. In some embodiments, the input system 906 may include touch-based inputs, such capacitive-and/or resistive-based buttons or other types of touch-based inputs. In some embodiments, the input system 906 may include force-based inputs, such as force-responsive buttons or other types of force-responsive inputs. In some embodiments, the input system may include 906 various types of video input (such as from one or more cameras) and/or audio input (such as from one or more microphones).

The optical device 900 includes sensors 908, which may include any of a wide variety of sensor types, such as force sensors, proximity sensors, temperature sensors, current sensors, voltage sensors, magnetometers, accelerometers, etc. The sensors 908 include the components associated with the fiber optic thermometry system (e.g., fiber optic thermometry system 100), such as described herein. For example, sensors 908 includes optical components (e.g., optical coupling 110, 710), one or more optical emitters (e.g., optical emitter(s) 108, light source 708), optical sensors (e.g., optical sensor(s) 112, first sensor 712, second sensor 713), and circuitry associated with processing signals acquired by the optical sensors. Electrical signals provided by the sensors may be provided to processor 902 for analysis, such as to determine a temperature based on one or both of the first optical output signal and second optical output signal (e.g., using method 800). In some embodiments, the processor 902 may control some aspects of the operation of the sensors 908. For instance, the processor 902 may control the output of the optical emitter(s).

The optical device 900 includes an electrical power system 910, which may include one or more batteries or other power sources. Additionally or alternatively, the electrical power system 910 may include a connector or power cord or cable that can be used to connect the optical device 900 or its components to a power source, such as a wall outlet, a remote battery pack, a tethered device, and/or other power source. The electrical power system 910 may include components for conditioning and distributing electrical power to the optical device 900. For instance, the electrical power source 910 may include regulators, power protection components, passive power electronic components, or a combination of these and/or other components. The electrical power system 910 may distribute power to other components, systems, and subsystems via one or more power supply buses, of bus 916.

The optical device 900 includes a communication system 912, which may enable the optical device 900 to transmit or receive data from another electronic device or devices. The communication system 912 may include components capable of wired and/or wireless (e.g., radio frequency (RF) and/or optical) communications. Examples of wireless and wired communications include cellular, Wi-Fi, BLUETOOTH®, ethernet, USB, HDMI, and/or other types of wired and wireless communications. In some variations, the optical device 900 may be associated with an external display, and the communication system 912 may provide video, audio, and/or other types of signals to the external display.

The optical device 900 includes an output system 914, which may include components associated with providing data or information to the user. For example, the output system 914 may include light sources (e.g., LEDs, lamps, bulbs, etc.), speakers, haptic generators (such as for providing vibratory or other haptic output), and the like. The output system 914 may, in some embodiments, include one or more displays for providing visual (e.g., graphical) outputs to the user. The display(s) may use any of a variety of suitable display technologies, such as liquid crystal display (LCD), LED, organic light-emitting diodes (OLED), or the like. In some variations, the display may include a touch-sensitive display that allows the user to provide input to the optical device 900 via the display.

In some variations, the optical device 900 may be communicatively coupled to an external user interface (not depicted). For example, the optical device 900 may be connected to an external system (e.g., a laptop computer or other type of electronic system) via wired or wireless connection. The external system may allow the user to provide inputs to the optical device 900 (such as to control and/or configure the optical device 900) and may allow the user to receive outputs from the optical device 900 (such as temperature measurements and/or other information).

In various embodiments, optical device 900 may include some, none, or all of the various capabilities, apparatuses, physical features, systems, and subsystems described herein. Further, the systems included in the optical device 900 are not exclusive or otherwise limiting, and the optical device 900 may include alternative or additional systems, components, modules, programs, instructions, or the like, that may be necessary or useful to perform the functions described herein.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

Features, structures, configurations, components, techniques, etc. shown or described with respect to any given figure (or otherwise described in the application) may be used with features, structures, configurations, components, techniques, etc. described with respect to other figures. For example, any given figure of the instant application should not be understood to be limited to only those features, structures, configurations, components, techniques, etc. shown in that particular figure. Similarly, features, structures, configurations, components, techniques, etc. shown only in different figures may be used or implemented together. Further, features, structures, configurations, components, techniques, etc. that are shown or described together may be implemented separately and/or combined with other features, structures, configurations, components, techniques, etc. from other figures or portions of the instant specification. Further, for ease of illustration and explanation, figures of the instant application may depict certain components and/or sub-assemblies in isolation from other components and/or sub-assemblies of an electronic device, though it will be understood that components and sub-assemblies that are illustrated in isolation may in some cases be considered different portions of a single electronic device (e.g., a single embodiment that includes multiple of the illustrated components and/or sub-assemblies).

Directional terminology, such as “top”, “bottom”, “upper”, “lower”, “front”, “back”, “over”, “under”, “above”, “below”, “left”, “right”, etc. is used with reference to the orientation of some of the components in some of the figures described herein. Because components in various embodiments can be positioned in a number of different orientations, directional terminology is used for purposes of illustration only and is in no way limiting. The directional terminology is intended to be construed broadly, and therefore should not be interpreted to preclude components being oriented in different ways. Additionally, when referring to positions of components, the directional terminology used herein does not necessarily refer to an absolute position relative to an external reference, but instead may refer to the relative position of components within the figure being referred to. Similarly, horizontal and vertical orientations may be understood as relative to the orientation of the components within the figure being referred to, unless an absolute horizontal or vertical orientation is indicated.

Also, as used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

What is claimed is:

1. A system, comprising:
an enclosure;
a temperature-sensitive material positioned within the enclosure;
an interconnect to couple optical signals between the temperature-sensitive material and an optical device;
wherein the optical device receives a first optical signal from the interconnect and provides a first temperature measurement in a first temperature range, based on the first optical signal; and
wherein the optical device receives a second optical signal from the interconnect and provides a second temperature measurement in a second temperature range, based on the second optical signal.

2. The system of claim 1, wherein the first optical signal is based on photoluminescence of the temperature-sensitive material and the second optical signal is based on Planck emissions of the temperature-sensitive material.

3. The system of claim 2, wherein the optical device comprises a sensor that provides first temperature data based on the first optical signal and second temperature data based on the second optical signal, and wherein the first temperature measurement in the first temperature range is based on the first temperature data and the second temperature measurement in the second temperature range is based on the second temperature data.

4. The system of claim 2, wherein the optical device comprises a first sensor to provide first temperature data based on the first optical signal and a second sensor to provide second temperature data based on the second optical signal, and wherein the first temperature measurement in the first temperature range is based on the first temperature data and the second temperature measurement in the second temperature range is based on the second temperature data.

5. The system of claim 4, wherein the first sensor and second sensor are positioned in a common sensor package.

6. The system of claim 4, wherein the first sensor comprises a photodiode and the second sensor comprises gallium arsenide.

7. The system of claim 1, wherein the first temperature range comprises a first temperature and the second temperature range comprises a second temperature, and the first temperature is less than the second temperature.

8. The system of claim 7, wherein the first temperature measurement is used as a reference for the second temperature measurement.

9. The system of claim 1, wherein:
the temperature-sensitive material is a first temperature-sensitive material;
the system further comprises a second temperature-sensitive material positioned within the enclosure;
the first optical signal is based on photoluminescence of the first temperature-sensitive material; and
the second optical signal is based on Planck emissions of the second temperature-sensitive material.

10. The system of claim 1, wherein the interconnect is coupled to the enclosure using a crimp connection.

11. A method, comprising:
receiving a first optical signal from an interconnect;
determining a first temperature of a first temperature-sensitive material in a first temperature range based on the first optical signal;
receiving a second optical signal from the interconnect; and
determining a second temperature of the first temperature-sensitive material in a second temperature range based on the second optical signal.

12. The method of claim 11, wherein the first output optical signal is based on photoluminescence of at least the first temperature-sensitive material, and the second optical signal is based on Planck emission of at least the first temperature-sensitive material.

13. The method of claim 11, wherein the first optical signal is based on photoluminescence of at least the first temperature-sensitive material, and a portion of the second optical signal is further based on Planck emission of at least a second temperature-sensitive material.

14. The method of claim 11, further comprising:
receiving the first optical signal at a first sensor;
determining the first temperature in the first temperature range based on temperature data provided by the first sensor;
receiving the second optical signal at a second sensor; and
determining the second temperature in the second temperature range based on temperature data provided by the second sensor.

15. The method of claim 14, wherein the determined first temperature in the first temperature range is used as a reference for the determined second temperature in the second temperature range.

16. The method of claim 14, wherein the first sensor comprises a photodiode, and the second sensor comprises gallium arsenide.

17. A temperature measurement system, comprising:
an enclosure;
a first temperature-sensitive material within the enclosure and a second temperature-sensitive material within the enclosure;
an optical fiber to couple light between the first temperature-sensitive material and a device, and between the second temperature-sensitive material and the device;
the device comprising:
a first sensor responsive to a first wavelength of light generated by the first temperature-sensitive material;
a second sensor responsive to a second wavelength of light generated by the second temperature-sensitive material;
a processor to receive first temperature data provided by the first sensor and second temperature data provided by the second sensor; and
wherein the processor uses the first temperature data to determine a first temperature measurement in a first temperature range and uses the second temperature data to determine a second temperature measurement in a second temperature range.

18. The temperature measurement system of claim 17, wherein the first temperature measurement is determined based on photoluminescence of the first temperature-sensitive material and the second temperature measurement is determined based on Planck emission of the second-temperature sensitive material.

19. The temperature measurement system of claim 18, wherein the first temperature measurement is used as a reference for determining the second temperature measurement.

20. The temperature measurement system of claim 18 wherein the first temperature measurement is further based on intensity decay of intensity of the first wavelength of light, and the second temperature measurement is further based on an intensity of the second wavelength of light.
